(19) United States
(12) Patent Application Publication
(10) Pub. No.: US 2020/0172397 A1
(43) Pub. Date: Jun. 4, 2020

(54) SYNTHESIS OF NITROGEN RICH 2D MESOPOROUS CARBON NITRIDE WITH ROD SHAPED MORPHOLOGY AND TUNABLE PORE DIAMETERS

(71) Applicant: SABIC Global Technologies B.V., Bergen op Zoom (NL)

(72) Inventors: Dae-Hwan PARK, Mawson Lakes (AU); Kripal S. LAKHI, Mawson Lakes (AU); Ugo RAVON, Thuwal (SA); Khalid ALBAHILY, Thuwal (SA); Jessica SCARANTO, Thuwal (SA); Ajayan VINU, Mawson Lakes (AU)

(21) Appl. No.: 16/617,289

(22) PCT Filed: May 22, 2018
(86) PCT No.: PCT/IB2018/053617

§ 371 Date: Nov. 26, 2019

Related U.S. Application Data
(60) Provisional application No. 62/513,805, filed on Jun. 1, 2017.

(51) Int. Cl. C01B 21/06; B01J 20/30; B01J 20/02; B01J 20/28

(52) U.S. Cl. CPC C01B 21/0605; B01J 20/3057; B01J 20/0259; B01J 20/3078; B01J 20/3071; B01J 20/28061; C01P 2006/14; C01P 2006/12; B01D 2257/504; B01D 2253/10; B01D 2253/311; C01P 2004/20; B01D 2253/306; B01J 20/28069

(57) ABSTRACT

Certain embodiments of the invention are directed to nitrogen rich two dimensional hexagonal C₃N_{4.6} mesoporous graphitic carbon nitride (gMCN) material formed from cyclic amino-triazole precursors, the gMCN having a rod shape morphology and an average pore diameter between 4 to 6 nm.

### CROSS REFERENCE TO RELATED APPLICATIONS

This application claims the benefit of priority of U.S. Provisional Patent Application No. 62/513,805 filed Jun. 1, 2017, which is hereby incorporated by reference in its entirety.

### BACKGROUND OF THE INVENTION

### A. Field of the Invention

The invention generally concerns a composition or catalyst for carbon dioxide capture. In particular the composition or catalyst includes a two-dimensional mesoporous carbon nitride having a rod shaped morphology that provides for carbon dioxide adsorption and/or activation.

### B. Description of Related Art

It is well known that carbon dioxide (CO₂) emissions are at least partially responsible for global warming. One strategy for decreasing CO₂ emissions into the atmosphere is to use CO₂ as feedstock for other processes, thus utilizing the CO₂ instead of releasing it into the atmosphere. For this reason, many researchers have tried to activate or capture the CO₂ molecule through the use of various materials. However, due to the high stability of this molecule, CO₂ activation is extremely challenging, which oftentimes results in inefficient catalytic activity.

A class of mesoporous carbon nitride (MCN) materials has been considered for potential application in the fields of catalysis, gas adsorption, and energy conversion due to their unique electronic, optical, and basic properties (Lakhi et al., Chem. Soc. Rev., 2016; Wang et al., Nat. Mater., 2009, 8:76; Zheng et al., Energy Environ. Sci., 2012, 5:6717). The synthesis of MCNs has been realized via hard-templating approach using mesoporous silica as a sacrificial template. Recently, researchers have reported the development of various structural and textural properties for high surface areas, different pore sizes, uniform morphology, as well as the control of surface functionalities, nitrogen content, and band gaps and positions (Talapaneni et al., ChemSusChem, 2012, 5:700; Jin et al., Angew. Chem. Int. Ed., 2009, 48:7884; Zhong et al., Sci. Rep., 2015, 5:12901; Lakhi et al., RSC Adv., 2015, 5:40183; Chinese Patent Publication No. 204326446 to Jie et al.; Li et al. Nano Res., 2010, Vol. 3, pp. 632-642).

Although the reported MCN materials have showed textural features for various catalytic performances and gas adsorption capacities, the use of these materials for CO₂ activation remains elusive. The currently available MCN materials typically have relatively low catalytic activity, which severely hinders the commercial scalability of such materials.

### SUMMARY OF THE INVENTION

MCN materials of the current invention provide a solution to the adsorption and catalysis problems associated with CO₂ capture and activation. In particular, improved nitrogen rich two dimensional hexagonal C₃N₄₊ (e.g., having a N/C molar ratio greater than 1.33) mesoporous graphitic carbon nitride (gMCN) material formed from cyclic amino-triazole precursors have been developed for capture and/or activation of CO₂. By way of example, the inventors have discovered a process to produce the gMCN material, which results in the material having appropriate structural characteristics that enhance CO₂ sequestration and/or activation. Without wishing to be bound by theory, it is believed that the use of cyclic amino-triazole precursors results in rod-shaped gMCN materials that have suitable surface area, pore diameters, and/or activity to capture CO₂ from a liquid or gas stream.

Certain embodiments of the invention are directed to nitrogen rich two dimensional hexagonal C₃N₄₊ mesoporous graphitic carbon nitride (gMCN) material formed from cyclic amino-triazole precursors, the gMCN having a rod shape morphology and an average pore diameter between 4 to 6 nm. In certain aspects the cyclic amino-triazole precursors is 3-amino-1,2,4-triazole. In certain aspects the material has a Brunauer-Emmett-Teller (BET) surface area of 200 to 400 m²/g, preferably 230 to 300 m²/g. The material can have a total pore volume of 0.4-0.7 cm³/g. In certain aspects the gMCN has a CO₂ adsorption capacity of 7.5 to 10.0 mmol/g at 273K and 30 bar. In some embodiments, the pore distribution is monomodal having an average pore diameter of 4 to 6 nm. In another embodiment, the pore distribution is bimodal having pores centered around 4 nm and 6 nm.

Other embodiments are directed to methods of synthesizing a two dimensional carbon nitride material formed from a cyclic amino-triazole precursor comprising: (a) contacting a SBA-15 silica template with an aqueous cyclic amino-triazole and hydrogen chloride (HCl) precursor solution forming a templated reaction mixture, wherein the silica template is formed by (i) adding tetraethyl orthosilicate (TEOS) to a mixture of P-123 surfactant and hydrogen chloride (HCl) forming a template reaction mixture; (ii) incubating the template reaction mixture at a temperature of about 35 to 45° C. for 1 to 4 hours; (iii) heating the template reaction mixture to 100-200° C. for 1 to 4 days forming a heated template reaction mixture; (iv) drying the heated template reaction mixture at 100° C. for 5 to 10 hours forming a dried template reaction mixture; and (v) washing the dried template reaction mixture with ethanol forming the SBA-15 template; (b) heating the templated reaction mixture to a temperature between 40 and 200° C., preferably between 80 and 120° C. for 4 to 8 hours forming a first heated reaction mixture; (c) heating the first heated reaction mixture to a temperature between 100 and 200° C., preferably between 140 to 180° C., more preferably between 130 to 150° C. for 4 to 8 hours forming a second heated reaction mixture; (d) carbonizing the second heated reaction mixture by heating to about 500° C. for 4 to 6 hours forming a hard template/cyclic amino-triazole-based carbon nitride product; and (e) removing the hard template forming a nitrogen rich two dimensional rod shaped mesoporous graphitic carbon nitride (gMCN). In certain aspects the template reaction mixture is heated at a temperature of about 130° C. forming a SBA-15-130 template or a temperature of about 150° C. forming a SBA-15-150 template. The method can further comprise crushing the second heated reaction mixture prior to the carbonizing. In other aspects, the method can further comprise bringing the second heated mixture to carbonization temperature using a ramping rate of 2 to 4° C./min. The carbonizing can be performed under constant nitrogen flow. In a further aspect, the cyclic amino-triazole precursor is 3-amino-1,2,4-triazole. The first heated reaction mixture can be held at a temperature of 130° C. or a temperature of 150° C. The template can be removed by treating the hard template/cyclic amino-triazole-based carbon nitride product with hydrogen fluoride or an ethanol wash.

Certain embodiments are directed to a CO₂ capture process comprising: (a) contacting a nitrogen rich two dimensional C₃N₄₊ mesoporous graphitic carbon nitride (gMCN) formed from cyclic amino-triazole precursors, the gMCN having a rod shape morphology and average pore diameter being between 4 to 6 nm, with a CO₂ containing feed source forming a reactant mixture, wherein CO₂ is absorbed in or to gMCN; and (b) holding the reactant mixture forming a CO₂ conversion product.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The term “substantially” and its variations are defined to include ranges within 10%, within 5%, within 1%, or within 0.5%.

The terms “inhibiting” or “reducing” or “preventing” or any variation of these terms includes any measurable decrease or complete inhibition to achieve a desired result.

The term “effective,” as that term is used in the specification and/or claims, means adequate to accomplish a desired, expected, or intended result.

The terms “wt. %,” “vol. %,” or “mol. %” refers to a weight, volume, or molar percentage of a component, respectively, based on the total weight, the total volume, or the total moles of material that includes the component. In a non-limiting example, 10 moles of component in 100 moles of the material is 10 mol. % of component.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The gMCN materials and processes of making and using these materials of the present invention can “comprise,” “consist essentially of,” or “consist of” particular ingredients, components, compositions, method steps, etc., disclosed throughout the specification. With respect to the transitional phase “consisting essentially of,” in one non-limiting aspect, a basic and novel characteristic of the gMCN materials of the present invention are their ability to efficiently adsorb and/or activate CO₂.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIGS. 1A-1B. Powder XRD patterns of SEW-SBA-T-AMT (FIG. 1A) Low angle (FIG. 1B) Wide angle.

FIGS. 2A-2B. (FIG. 2A) N₂ adsorption isotherms. (FIG. 2B) Pore size distribution of SEW-SBA-T-AMT samples.

FIGS. 3A-3C. (FIG. 3A) SEM Images of SEW-SBA-130+AMT. (FIG. 3B) SEM Images of SEW-SBA-150+AMT. (FIG. 3C) HR-TEM Images of SEW-SBA-150+AMT sample (a) Low magnification and (b) High magnification.

FIG. 4. FT-IR spectra of SEW-SBA-T-AMT samples.

FIGS. 5A-5C. (FIG. 5A) Survey spectra of SEW-SBA-T-AMT samples. (FIG. 5B) High resolution C1s scan for SEW-SBA-130-AMT and SEW-SBA-150-AMT. (FIG. 5C) High resolution N1s scan for SEW-SBA-130-AMT and SEW-SBA-150-AMT.

FIGS. 6A-6B. (FIG. 6A) C K-edge and (FIG. 6B) N K-edge NEXAFS spectra of the (a) SEW-SBA-15-150-AMT and (b) non-porous g-C₃N₄ prepared by dicyandiamide at 550° C.

FIG. 7. CO₂ adsorption isotherms for SEW-SBA-T-AMT samples at 273 K and 30 bar.

FIGS. 8A-8B. CO₂ adsorption isotherms at 0 and 10° C. (FIG. 8A) SEW-SBA-130-AMT (FIG. 8B) SEW-SBA-150-AMT.

FIGS. 9A-9B. Isosteric heat of adsorption calculated using Clausius-Clapeyron equation (FIG. 9A) SEW-SBA-130-AMT (FIG. 9B) SEW-SBA-150-AMT.

FIGS. 10A-10B. (FIG. 10A) Low angle XRD patterns of SEW-SBA-15-T silica samples. (FIG. 10B) N₂ adsorption-desorption isotherms of SEW-SBA-15-T silica samples.

FIGS. 11A-11B. HR-SEM images of SEW-SBA-15-T silica template (FIG. 11A) 130° C. and (FIG. 11B) 150° C.

FIGS. 12A-12B. (FIG. 12A) Illustrates a schematic representation of the use of the gMCN-material to capture CO₂ (FIG. 12B) Illustrates a schematic representation of the use of the gMCN material to produce activated CO₂.

### DETAILED DESCRIPTION OF THE INVENTION

Mesoporous carbon nitrides (MCN) were discovered in 2005. Since then a new class of MCN with two- or three-dimensional structure and large pore diameters has been reported. This new class of MCN has potential applications in the fields of catalysis, gas adsorption, and energy conversion due to unique textural and surface features, optical, and electronic properties. In general, MCN materials with different structures and pore diameters can be synthesized using a variety of mesoporous silica as sacrificial templates. More recently, three-dimensional structured MCNs with large pore size, high surface area, and uniform morphology have been reported. However, although the reported MCN materials have showed unique textural parameters for various catalytic performances and gas adsorption capacities, additional MCN with new structures and high nitrogen content is still desired for improving their performance as it relates to CO₂ capture and activation.

The inventors have discovered a process to produce mesoporous carbon nitride material having the appropriate characteristics for CO₂ sequestration and/or activation. The discovery is premised on a preparation method that uses cyclic amino-triazole precursors to produce rod-shaped MCN materials having suitable surface area, pore diameters, and activity to capture CO₂ from a liquid or gas stream.

As described herein, the inventors demonstrate the successful synthesis of a 2D MCN having hexagonally arranged pore system, highly ordered mesostructure, and high surface area. The 2D MCN is based on a SBA-15 silica template and is prepared via a calcination free route using a nitrogen containing cyclic amino-triazole precursors (e.g., 3-amino-1,2,4-triazole) as a single molecule cyclic carbon and nitrogen precursor. Additionally, the inventors have characterized the CO₂ adsorption capacity of the prepared MCNs and investigated the application of the MCNs in CO₂ capture and photocatalytic reduction of the CO₂ molecules into useful value added chemicals. These and other non-limiting aspects of the present invention are discussed in further detail in the following sections with reference to the Figures.

A. Process for Preparing Nitrogen Rich Two-Dimensional Hexagonal C₃N₄₊Mesoporous Graphitic Carbon Nitride (gMCN)

The gMCN material can be formed by using a templating agent. A template can be a mesoporous silica. In one aspect, the mesoporous silica can be an SBA-15 silica material or derivatives thereof

1. Process to Prepare Template

The silica template can be synthesized under static conditions using a templating approach performed under acidic conditions. The templating agent can be a polymeric compound such as an amphiphilic triblock copolymer of ethylene oxide and propylene oxide having various molecular weights. A commercially available amphiphilic triblock copolymer templating agent is available from BASF (Germany) and sold under the trade name Pluronic P-123 (e.g., EO₂₀PO₇₀EO₂₀). The silica source can be any suitable silica containing compounds such as sodium silicate, tetramethyl orthosilicate, silica water glass, etc. A non-limiting example of the silica source is tetraethyl orthosilicate (TEOS), which is available from various commercial suppliers (e.g., Sigma-Aldrich®, U.S.A.). An aqueous solution of templating agent (e.g., the amphiphilic triblock copolymer) can be prepared by adding the templating agent to water and stirring the aqueous solution at 20 to 30° C., 23 to 27° C., or 25° C. until the reaction mixture is homogeneous (e.g., 3 to 5 hour). Aqueous mineral acid (e.g., 2 M HCl) can be added to the templating solution to obtain a solution having a pH of 2 or less. After addition of the acid, the temperature of the templating solution can be increased to 35 to 50° C., or 40° C. and agitated for a desired amount of time (e.g., 1 to 5 hours, or 2 hours). The silica source (e.g., TEOS) can be added under agitation to the templating solution for a desired amount of time (e.g., 10 to 30 minutes) and then held (incubated) without agitation (e.g., 24 hours) to form the polymerization solution containing the templating agent and the silica source. The polymerization solution can then be reacted under hydrothermal reaction conditions to form a silica template for a desired amount of time (e.g., 40 to 60 hours, or 45 to 55 hours, or 48 hours). In some embodiments, the reaction conditions can be autogenous conditions. A reaction temperature can range from 100° C. to 200° C., 110° C. to 180° C., 130° C. to 150° C., or any value or range there between. The reaction temperature can be used to tune the pore size of the silica template. By way of example, heating the reaction mixture to 100° C. under autogenous conditions for about 48 h can result in a silica template having a pore size of about 9.12 nm. Increasing the temperature from 100° C. to 130° C. can result in a 10 to 15% increase in pore size (e.g., to 10.5 nm). As the temperature is increased to 150° C., the pore size is further increased by 5 to 10% (e.g., to 11.2 nm, or an overall increase of 15 to 20%, or 18%). Wall thickness of the silica template can also be tuned by the reaction temperature. By way of example, higher reaction temperatures can produce thinner walls.

The silica template can be separated from the polymerization solution using known separation methods (e.g., gravity filtration, vacuum filtration, centrifugation, etc.) and washed with water to remove any residual polymeric solution. In a particular embodiment, the template is filtered hot. The filtered silica template can be dried to remove the water. By way of example, the filtered silica template can be heated at 90 to 110° C. until the silica template is dry (e.g., 6 to 8 hours). The dried filtered silica template can be extracted with alcohol (e.g., ethanol, methanol, propanol, etc.) at 20 to 30° C. (e.g., room temperature and in the absence of external heating or cooling) to remove any residual templating agent (e.g., copolymer and/or polymerized material). In a non-limiting example, the dried filtered silica template can be repeatedly agitated in fresh ethanol solutions until at least 80%, at least 90%, at least 92%, at least 95%, or at least 100% of the templating agent is removed. The ethanol extracted silica template can be dried to remove the alcohol and form a dried rod-shaped non-calcined silica template. In a particular embodiment, the non-calcined silica template is rod-shaped non-calcined mesoporous SBA-15 silica. The SBA-15 silica template can have a pore diameter ranging from 7 nm to 13 nm, 8 nm to 12 nm, or 7 nm, 7.1 nm, 7.2 nm, 7.3 nm, 7.4 nm, 7.5 nm, 7.6 nm, 7.7 nm, 7.8 nm, 7.9 nm, 8 nm, 8.1 nm, 8.2 nm, 8.3 nm, 8.4 nm, 8.5 nm, 8.6 nm, 8.7 nm, 8.8 nm, 8.9 nm, 9 nm, 9.1 nm, 9.2 nm, 9.3 nm, 9.4 nm, 9.5 nm, 9.6 nm, 9.7 nm, 9.8 nm, 9.9 nm, 10 nm, 10.1 nm, 10.2 nm, 10.3 nm, 10.4 nm, 10.5 nm, 10.6 nm, 10.7 nm, 10.8 nm, 10.9 nm, 11 nm, 11.1 nm, 11.2 nm, 11.3 nm, 11.4 nm, 11.5 nm, 11.6 nm, 11.7 nm, 11.8 nm, 11.9 nm, 12 nm, 12.1 nm, 12.2 nm, 12.3 nm, 12.4 nm, 12.5 nm, 12.6 nm, 12.7 nm, 12.8 nm, 12.9 nm, or any value there between. A wall thickness of the SBA silica template can range from 0.1 to 3 nm, or 0.3 to 2.8 nm, or 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 or 3.0 nm or any value there between.

2. Process to Prepare an gMCN Material

The rod-shaped GMCN material can be prepared using the non-calcined silica template (e.g., rod-shaped uncalcined SBA-15) described above and throughout the specification. The silica template pores can be filled with a carbon nitride precursor material(s) to form a template/carbon nitride precursor mixture. By way of example, the non-calcined SBA-15 silica material can be added to a cyclic amino-triazole precursor (e.g., 3-amino-1,2,4-triazole). The template/carbon nitride precursor mixture can be subjected to conditions suitable to form a carbon nitride composite having the shape of the template (e.g., rod shaped). The template/carbon nitride mixture can be subjected to an initial incubation at a temperature of 80 to 100° C., or 85 to 95° C., or about 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C. or 100° C., or any value there between. After the initial incubation, the mixture is held at an increased temperature of 140 to 180° C., preferably 160° C. for 4 to 8 h, or about 6 h. In some embodiments, the solution is refluxed under constant agitation for 5 to 8 hours, or 6 hours, forming a template/carbon nitride (CN) composite. The template/CN composite can be separated from the solution using known separation methods (e.g., distillation, evaporation, filtration, etc.). By way of example, the solution can be removed from the template/CN composite by evaporating the solution under vacuum. The resulting template/CN composite can be dried, and then reduced in size with force (e.g., crushed). Drying temperatures can range from 90 to 110° C., or 100° C.

The dried template/CN composite can be subjected to conditions sufficient to carbonize the material and form a mesoporous carbon nitride material/template complex (e.g., SBA-15 (SEW-SBA-15) complex). Carbonizing conditions can include a heating the template/CN composite to a temperature of at least 500° C., at least 600° C., at least 700° C., at least 800° C., at least 900° C., at least 1000° C., or 1100° C. In certain aspects, the template/CN composite is heated to 500° C. Notably, the rod-shape of the material does not change during carbonization (e.g., the material maintains a rod-shape after it has been carbonized). The nitrogen properties and textural properties of the gMCN material can be tuned by using a specific carbonization temperature. By way of example, the pore diameter of the resulting gMCN material can increase with increasing carbonization temperature up to 900° C. At a temperature of 900° C. or more, the textural properties become saturated and remain substantially unchanged. Nitrogen content can be also be tuned by varying the carbonization temperature. With increasing carbonization temperature, there can be a progressive increase in the C atomic % while there a proportional decrease in the N atomic %. Without wishing to be bound by theory, it is believed that at higher temperatures, N tends to escape from the system by breaking bonds. By way of example, a template/CN composite heated at 600° C. can have an N atomic % of about 16%, and after heating at 1100° C. have a N atomic % of about 3%. The carbon content can also be tuned based on a selected temperature as the atomic carbon content increases as the temperature rises. By selecting a desired carbonization temperature, the C/N atomic ratio of the mesoporous carbon nitride material of the present invention can be tuned. In one particular embodiment, a carbonization temperature of 500° C. provides a nitrogen to carbon (N/C) ratio of about 1.35 to 1.6.

The template can be removed from the carbonized material (e.g., the mesoporous carbon nitride material/template composite) by subjecting it to conditions sufficient to dissolve the template and form the mesoporous carbon nitride material of the present invention. By way of example, the template can be dissolved using an hydrofluoric acid (HF) treatment, a very high alkaline solution, or any other dissolution agent capable of removing the template and not dissolving the CN framework. The kind of template and the CN precursor used influence the characteristics of the final material. The resulting rod-shaped GMCN material of the present invention can be washed with solvent (e.g., ethanol) to remove the dissolution material, and then dried (e.g., heated at 100° C.).

### B. Graphitic Mesoporous Carbon Nitride Materials

The rod-shaped gMCN material can have an average pore size or pore diameter of 4 nm, 5 nm, 6 nm, or 7 nm. Specifically the pore size can range from 4 to 6 nm, or about 3.8, 3.9, 4.0, 4.1, 4.2, 4.3, 4.4, 4.5, 4.6, 4.7, 4.8, 4.9. 5.0, 5.1, 5.2, 5.3, 5.4, 5.5, 5.6, 5.7, 5.8, 5.9, or 6.0 nm. The pore volume of the mesoporous material can range from 0.4-0.7 cm³/g or any value or range there between (e.g., 0.40, 0.41, 0.42, 0.43, 0.5, 0.51, 0.52, 0.53, 0.54, 0.55, 0.56, 0.57, 0.58, 0.59, 0.60, 0.61, 0.62, 0.63, 0.64, 0.65, 0.67, 0.68, 0.69, or 0.70 cm³ g⁻¹). Preferably, the pore volume is 0.4 to 0.7 cm³ g⁻¹. The BET surface area of the can be from 200 to 400 m²/g, preferably 230 to 300 m²/g. In certain embodiments a rod-shaped CN material made from a silica template prepared at 130° C. or 150° C. The N/C ratio of the gMCN material can be at least, equal to, or between any two of 1.35, 1.4, 1.5, and 1.6. In a preferred embodiment the N/C ratio is 1.4 to 1.6, preferably 1.4 to 1.5.

### C. Use of the Mesoporous Carbon Nitride Materials

The rod-shaped gMCN materials can be used in applications for sequestration or activation of carbon dioxide. Certain embodiments of the invention are directed to systems for CO₂ sequestration, capture, and activation.

According to one embodiment of the present invention, a process for CO₂ capture is described. In step one of the process, a feed stock comprising CO₂ is contacted with gMCN. The feed stock can include a concentration of CO₂ from 0.01 to 100% and all ranges and values there between (e.g., 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.22, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.50, 0.51, 0.52, 0.53, 0.54, 0.55, 0.56, 0.57, 0.58, 0.59, 0.60, 0.61, 0.62, 0.63, 0.64, 0.65, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100%). The % of CO₂ in the feed stock can be measured in wt. % or mol. % or volume % based on the total wt. % or mol. % or volume % of the feed stock respectively. In a preferred aspect, the feedstock can be ambient atmospheric or a gas effluent from a CO₂ producing process. In one non-limiting instance, the CO₂ can be obtained from a waste or recycle gas stream (e.g., a flue gas emission from a power plant on the same site such as from ammonia synthesis or a reverse water gas shift reaction) or after recovering the carbon dioxide from a gas stream. A benefit of recycling carbon dioxide as a starting material can reduce the amount of carbon dioxide emitted to the atmosphere (e.g., from a chemical production site). The feedstock containing CO₂ can contain additional gas and/or vapors (e.g., nitrogen (N₂), oxygen (O₂), argon (Ar), chloride (Cl₂), radon (Ra), xenon (Xe), methane (CH₄), ammonia (NH₃), carbon monoxide (CO), sulfur containing compounds (RₓS), volatile halocarbons (all permutations of HFCs, CFCs, and BFCs), ozone (O₃), partial oxidation products, etc.). In some examples, the remainder of the feedstock gas can include another gas or gases provided the gas or gases are inert to CO₂ capture and/or activation for further reaction so they do not negatively affect the gMCN material. In instances where another gas or vapor do have negative effects on the CO₂ capture process (e.g., conversion, yield, efficiency, etc.), those gases or vapors can be selectively removed by known processes. Preferably, the reactant mixture is highly pure and substantially devoid of water. In some embodiments, the CO₂ can be dried prior to use (e.g., pass through a drying media) or contain a minimal amount of water or no water at all. Water can be removed from the reactant gases with any suitable method known in the art (e.g., condensation, liquid/gas separation, etc.).

The process can further comprise, holding the reactant mixture (incubating) under conditions in which CO₂ is attached to the mesoporous material. For example, the CO₂ can be adsorbed to the mesoporous material or can covalently bind to a primary or secondary nitrogen group of the mesoporous material. The incubation conditions can include a temperature, pressure, and time. The temperature range for the incubation can be from 0° C. to 30° C., from 5° C. to 25° C., 10° C. to 20° C., and all ranges and temperatures there between. The pressure range for the incubation can be from 0.1 MPa to 3 MPa, or 1 to 2 MPa. In embodiments where adsorption/desorption processes are used, the pressure of adsorption is higher than a pressure of desorption. By way of example, a gas including methane, hydrogen, or other less adsorbing gases, the adsorbing CO₂ partial pressure can range from 0.1 to 3 MPa and the desorbing CO₂ partial pressure can range from 0 MPa to 2 MPa. The time of incubation can be from 1 sec to 60 seconds, 5 minutes to 50 minutes, 10 minutes to 30 minutes. The conditions for CO₂ capture can be varied based on the source and composition of feed stream and/or the type of the reactor used.

According to another embodiment of the current invention, the gMCN material containing attached CO₂, the CO₂ can be released to regenerate the gMCN material and release CO₂. Without limitation, equilibrium binding between the gMCN material and CO₂ can occur. In some aspects, an equilibrium binding constant can be determined and influenced by typical reaction condition manipulations (e.g., increasing the concentration or pressure of the reactant feed stock, etc.). The methods and system disclosed herein also include the ability to regenerate used/deactivated gMCN in a continuous process. Non-limiting examples of regeneration include a pressure swing adsorption (PSA) process at a lower pressure and/or a using a change of feed material. In some embodiments, the gMCN/CO₂ is disposed in an environmentally safe manner.

Certain embodiments of the invention are directed to systems for CO₂ capture. In general aspects, a first stage of a system for CO₂ capture includes moving a flowing mass of ambient air having the usual relatively low concentration of CO₂ in the atmosphere, with a relatively low pressure drop (in the range of 100-1000) pascals. The flow of CO₂ containing air from the first stage, can be passed, in a second stage, through a large area bed, or beds, of sorbent (e.g., including a gMCN of the present invention) for the CO₂, the bed having a high porosity and on the walls defining the pores a highly active CO₂ adsorbent.

In general aspects, the first stage of a system for CO₂ capture includes moving a flowing mass of ambient air having the usual relatively low concentration of CO₂ in the atmosphere, with a relatively low pressure drop (in the range of 100-1000) pascals. The flow of CO₂ containing air from can be passed through a large area bed, or beds, of sorbent (e.g., including gMCN) for the CO₂, the bed having a high porosity and on the walls defining the pores a highly active CO₂ adsorbent.

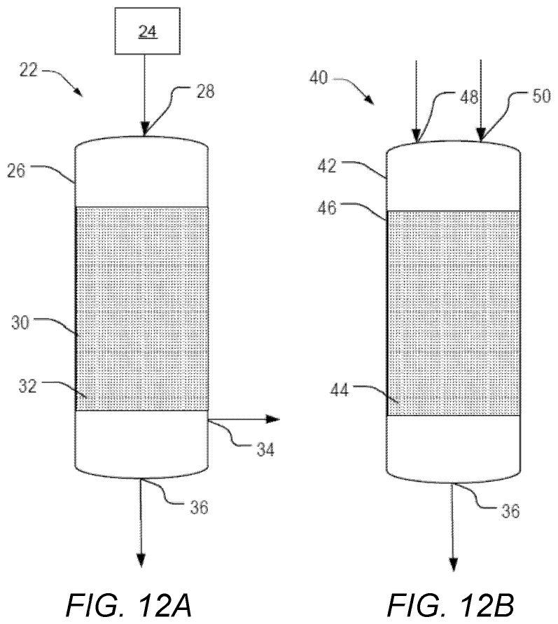

Other embodiments include systems for CO₂ capture and activation to form a reaction product. Referring to FIG. 12A and FIG. 12B, systems are illustrated, which can be used to capture CO₂ using the MCN-TU material of the present invention and/or activate the CO₂. The system 22 can include a feed source 24, a separation unit 26. The feed source 24 can be configured to be in fluid communication with the separation unit 26 via an inlet 28 on the separation unit. The feed source can be configured such that it regulates the amount of CO₂ containing material entering the separation unit 26. The separation unit 26 can include at least one separation zone 30 having the gMCN material 32 of the present invention. Although not shown, the separation unit may have additional inlets for the introduction of gases that can be added to the separation unit as mixtures or added separately and mixed within the separation unit. Optionally, these additional inlets may also be used as an evacuation outlet to remove and replace the atmosphere within the separation unit with inert atmosphere or reactant gases in pump/purge cycles. To avoid the need to remove atmosphere from the separation unit, the entire separation unit can kept under inert atmosphere. The separation unit 26 can include an outlet 34 for uncaptured gases in the separation unit. The separation unit can be depressurized or chemically treated to remove the desorbed or bound CO₂ from the gMCN material. A second unit can be used in combination with separation unit 26 to provide a continuous process. The released CO₂ can exit the separation unit from outlet 36 and be collected, stored, transported, or provided to other processing units for further use.

Referring to FIG. 12B, system 40 is system used to activate CO₂ for use in producing alcohols or carbonylated materials. Reactor 42 can include gMCN material 44 in reaction zone 46. CO₂ can enter reactor 42 via inlet 48 and an olefinic (e.g., olefin, substituted olefin, aromatic, substituted aromatic compound) can enter reactor 42 via inlet 50. The CO₂ and olefinic material can mix in reactor 42 to form a reactant mixture. In some embodiments, the CO₂ and olefinic material can be provided as one stream to reactor 42. In reaction zone 46 as the CO₂ and olefinic material pass over the gMCN material, the basic nitrogen sites on the gMCN material can activate or bond to the CO₂ and promote addition of an oxygen and/or a CO to the olefinic compound. By way of example, CO₂ and benzene can be contacted with the gMCN material to produce phenol and CO. The reactor 42 can be heated under desired pressures and temperatures to promote the reaction of CO₂ with the olefinic material. The reaction product can exit reactor 42 via product outlet 52 and be collected, stored, transported, or provided to other units for further processing. If necessary, the reaction product can be purified. For example, unreacted CO₂ and olefinic compound can be separated (e.g., separation system 22) and recycled to reactor 42. Systems 22 and 40 can also include a heating source (not shown). The heating source can be heaters, heat exchange systems or the like, and be configured to heat the reaction zone 42 or separation zone 4 to a temperature sufficient to perform the desired reaction or separation.

### EXAMPLES

The following examples as well as the figures are included to demonstrate preferred embodiments of the invention. It should be appreciated by those of skill in the art that the techniques disclosed in the examples or figures represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

Density functional theory (DFT) calculations suggest that defective carbon nitride can chemisorb and activate CO₂ at room and/or mild temperature. In particular, the activation of CO₂ to a bent geometry seems to be feasible in presence of high concentration of primary and secondary amino groups (NH₂ and NH) because of the formation of multiple H-bonds between the molecule and the carbon nitride framework. The computational results suggest also a relatively easy CO₂ desorption process due to moderate binding energy. The engineered carbon nitride material of the present invention promising for CO₂ capture as can represent a compromise between the other sorbent materials associated to physical or chemical adsorption mechanism. Based on the computational conclusion, a strategy has been elaborated in order to enhance the number of —NH₂ species and their accessibility. In order to enhance the —NH₂ species, different CN precursor like aminoguanidine or amino 1,2,4-triazole can be used as monomer. The addition of a co-monomer like urea or formaldehyde can also modify the structure of the polymer and enhance the target species.

Because polymerization occurs between —NH/—NH₂ species, and —N/—NH species for the aminoguinidine and the amino 1,2,4 triazole respectively, the number of —NH₂ species are significantly be enhanced by using these monomers.

Typically, mesoporous materials, like SBA-15, KIT-6, and FDU-12 are used as hard templates. The pore volume of those materials is filled by the CN precursors. Then, a thermal treatment is applied to for polymerization. After polymerization, the silica template is removed by an appropriate treatment. The morphology of the final material is the replica of the silica mesoporosity. By applying this approach, it is possible to facilitate the accessibility of the —NH₂ species and enhance the CO₂ reactivity.

### Example 1

### Preparation of SEW-SBA-15-T (T=130 or 150° C.) Silica Templates

The silica template SEW-SBA-15-T (SEW is an abbreviation for static ethanol wash) was synthesized under static conditions using a soft templating approach under strongly acidic conditions. After hydrothermal treatment at 130 or 150° C., the organic polymeric surfactant P-123 was removed by solvent extraction using ethanol at room temperature. In a typical synthesis, 2 g of non-ionic surfactant Pluronic P-123, which is a triblock copolymer (EO₂₀PO₇₀EO₂₀), Avg. mwt 5800, Sigma-Aldrich) was added to 15 g of water in a polypropylene (PP) bottle with a cap and the solution was stirred for 4 hr at room temperature followed by addition of 60 g of 2 M HCl and simultaneously the temperature was raised to 40° C. and the mixture was stirred for 2 hr. After this, 4.5 g of TEOS (tetraethyl orthosilicate, 98% Sigma-Aldrich) was added and the mixture was stirred for 20 min after which stirring was stopped completely and the sample was left undisturbed for the next 24 hr with the temperature in the water bath maintained at 40° C. The solution mixture was then transferred to a Teflon lined autoclave and kept in an oven at 130 or 150° C. for 48 hr. The product was filtered hot and washed three times with water. The filtered product was dried in an oven at 100 V for 6-8 hr and then washed twice with ethanol, each time stirred with ethanol for 3 hr at room temperature. The filtered sample was dried again in an oven overnight before further use and characterization.

### Example 2

### Preparation of 2D gMCN using 3-amino-1,2,4-triazol (AMT) (SEW-SBA-T-AMT)

MCNs labelled as SEW-SBA-T-AMT (T=temperature, AMT=3-amino-1,2,4-triazole) were prepared using a hard templating approach using SEW-SBA-15-T as the silica template and 3-Amino-1, 2, 4-triazole as a carbon and nitrogen precursors. In a typical synthesis, 3 g of 3-Amino-1, 2, 4-triazole (AMT) was dissolved in a solution prepared by mixing 4 g of DI water and 0.15 g of 37% HCl. The resulting solution was heated at 60° C. in a water bath or an oven for 2 to 15 minutes till a clear solution is obtained. The resulting solution was quickly poured onto 1 g of silica template SEW-SBA-15-130/150 from Example 1 and mixed thoroughly for about 15 minutes. After ensuring thorough mixing, the resulting pasty mixture was kept in an oven at 100° C. for 6 h and then the temperature was increased to 160° C. for maintained for another 6 h. The resulting sample was crushed in a mortar and pestle and kept at the center of an alumina boat and carbonized in a tubular furnace at 500° C. for 5 h with a heating rate of 3° C./min under nitrogen environment. The carbonized sample was then treated with 5 wt % aqueous solution of hydrofluoric acid to dissolve the silica template and recover porous carbon nitride. The powered sample was dried at 100° C. for 6 h before characterization.

### Example 3

### Material Characterization and CO₂ Adsorption Data

The silica templates SEW-SBA-15-T (T is the hydrothermal temperature T=130 and 150° C.) and the corresponding carbon nitrides SEW-SBA-T-AMT (AMT=3-Amino-1,2,4-Triazole) were characterized with low angle powder XRD. The Powder X-ray diffraction measurements were carried out on a PANalytical Empyream platform diffractometer using Bragg-Brentano geometry. The measurements were collected using Cu K_{α} radiation from a sealed tube source operating at 40 kV and 40 mA, a fixed divergence slit of 0.1 degree and a PIXcel′ detector. The scan rate used was 0.01 degree/sec. The low angle measurements were done in the 2 Theta range 0.1 to 5 degree and wide angle measurements were from 5 to 70 degrees. Nitrogen adsorption and desorption isotherms were measured at −196° C. on a Micromeritics ASAP 2420 surface area and porosity analyser. All the samples were degassed for 8 h at 250° C. under a vacuum (p<1×10⁻⁵ pa) in the degas port of the adsorption analyzer. The specific surface area was calculated using the standard BET model. Pore size distribution was obtained from the adsorption branches of the nitrogen isotherms using the BJH model. FT-IR spectra were recorded on Nicolet Magna-IR 750 fitted with a MTEC Model 300 Photoacoustic measuring 256 scans, at a resolution of 8 cm⁻¹, and a mirror velocity of 0.158 cm/s which equates to a sampling depth of ˜22 microns.

X-ray photoelectron spectroscopy (XPS) data was acquired using a Kratos Axis ULTRA X-ray Photoelectron Spectrometer incorporating a 165 mm hemispherical electron energy analyzer. The incident radiation was Monochromatic Al Kα X-rays (1486.6 eV) at 225 W (15 kV, 15 ma). Survey (wide) scans were taken at analyzer pass energy of 160 eV and multiplex (narrow) high resolution scans at 20 eV. Survey scans were carried out over 1200-0 eV binding energy range with 1.0 eV steps and a dwell time of 100 ms. Narrow high-resolution scans were run with 0.05 eV steps and 250 ms dwell time. Base pressure in the analysis chamber was 1.0×10⁻⁹ torr and during sample analysis 1.0×10⁻⁸ torr. Atomic concentrations were calculated using the CasaXPS version 2.3.14 software and a Shirley baseline with Kratos library Relative Sensitivity Factors (RSFs). Peak fitting of the high-resolution data was also carried out using the CasaXPS software. The structural morphology of the samples was observed in JEOL FE SEM 7001. The sample preparation for HR-SEM involved sprinkling of a small quantity of powder sample on the carbon tab. The stub is kept in a vacuum oven at 70° C. for 7 h before insertion into the SEM. The samples were coated with 5 nm layer of Iridium using Baltek coater at a nominal current of 15.5 mAps and coating time 60 sec. High pressure CO₂ adsorption was carried out on Quanta chrome Isorb HP1 equipped with temperature controlled circulator. The CO₂ adsorption was carried out at 30 bar and different analysis temperatures 273K and 283K was used. Prior to CO₂ adsorption, samples were degassed for 10 h at 250° C. The isosteric heat of adsorption was calculated using the Clausius-Clapeyron equation using the isotherms at 273K and 283K.

X-Ray Diffraction.

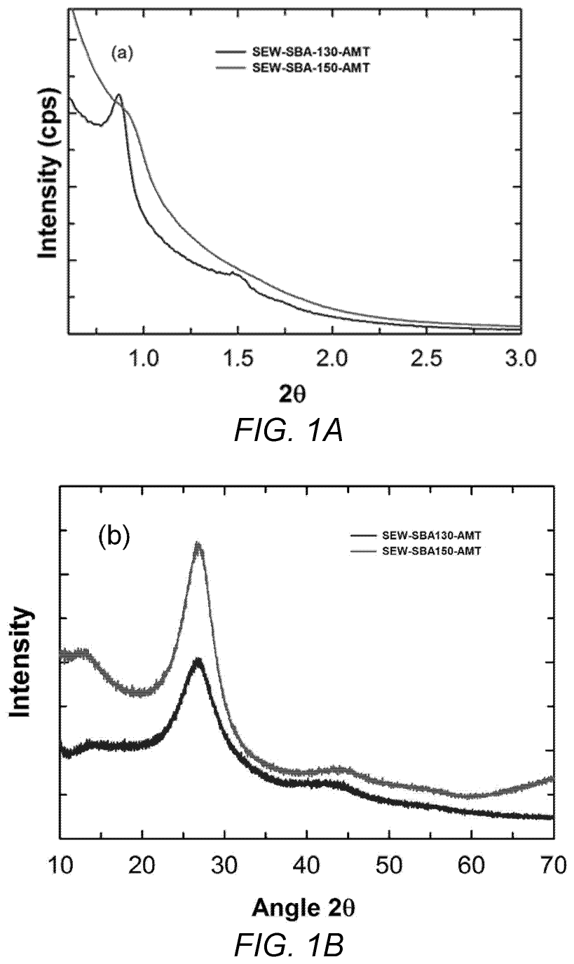

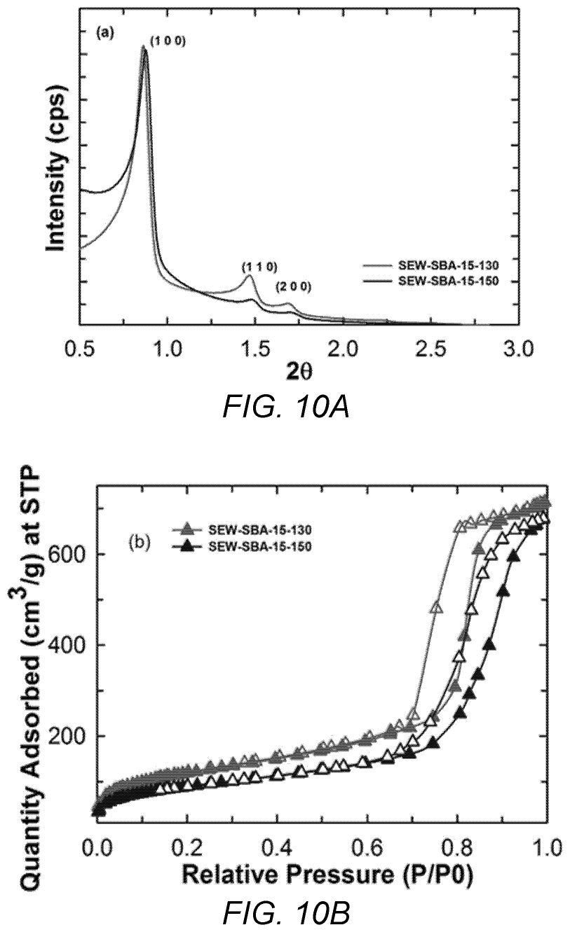

FIG. 1A shows the low angle XRD patterns of SEW-SBA-T-AMT samples. From the plots, it is clear that both the samples exhibit ordered structure. The XRD plot of SEW-SBA-130-AMT shows two distinct peaks, one low order sharp peak and a higher order peak indicating the presence of well-defined structural order. However, the plot of SEW-SBA-150-AMT sample shows only one low order peak. The XRD pattern suggests the presence of ordered structure however not as well-defined as in case of SEW-SBA-130-AMT sample. The difference in extent of structural ordering could be explained in terms of the extent of pore filling with the cyclic precursor. In a successful nanocasting procedure the structural order is replicated from the template to the final product. From the XRD patterns of the silica templates as shown in FIG. 10, templates prepared at 130 and 150° C. show well pronounced ordered structure, yet there is a difference in the structural ordering of the corresponding gMCN. The silica template prepared at 130 has small pore diameter compared to the silica template prepared at 150. During the synthesis the same quantity of precursor is added to both templates. From the XRD plot of SEW-SBA-150-AMT, it appears that for 150° C. sample, the pore filling is incomplete due to insufficient quantity of precursor because the formation of the polymeric network is not as good as that of the 130° C., resulting in disordered structure for SEW-SBA-150-AMT. The graphitic layer structured in the gMCN was investigated with wide angle XRD as shown in FIG. 1B. Both the samples show the presence of two main reflections at about approximately 2 theta=12.9° and 2 theta=26.8°. The peak at 26.8° suggests interplanar stacking of CN layers whereas the peak at 12.9° is indicative of in-plane repeating motif. These results are in close agreement with a recent reports. Further the intensity of the peak at 26.8° quantifies the extent of stacking. From FIG. 1B, SEW-SBA-150-AMT has slightly higher degree of stacking or more graphitic layered structure as compared to SEW-SBA-130-AMT.

N₂ Adsorption-Desorption.

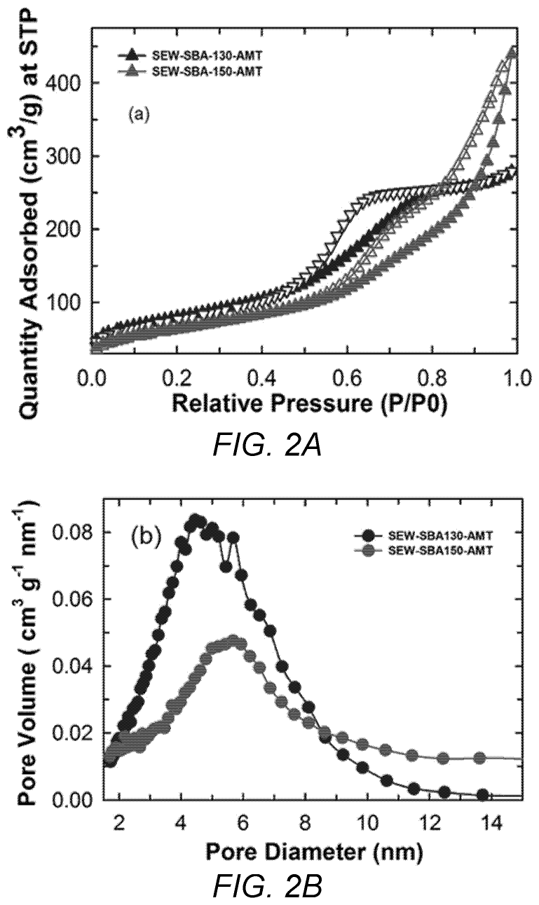

The mesoporous nature of the carbon nitride materials was investigated using N₂ adsorption-desorption technique. FIG. 2A shows the N₂ adsorption-desorption isotherms for SEW-SBA-T-AMT materials. Both the samples show type IV isotherm which is typically associated with mesoporous materials. Thus nitrogen sorption confirms the mesoporosity in the carbon nitride materials. Between the two samples, SEW-SBA-130-AMT sample exhibits higher BET surface area of 285 m²/g and a pore diameter of 4.4 nm whereas SEM-SBA-150-AMT which has larger pore diameter of 5.6 shows slightly lower surface area of 234 m²/g as shown in Table 1. The lower BET surface area of SEW-SBA-150-AMT is attributed to the partial collapse of the silica template during the hydrothermal treatment at 150° C. This observation is confirmed by the results from XRD analysis discussed earlier. An increase in pore diameter of the carbon nitride with increase in the hydrothermal treatment temperature of silica preparation is expected since pore tuning by varying the hydrothermal temperature is a well-established technique in material synthesis.

HR-SEM and HR-TEM Imaging.

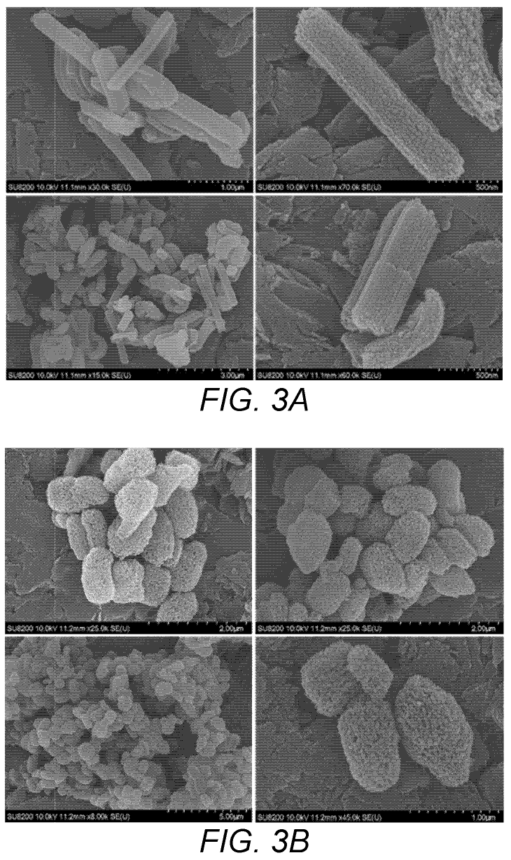

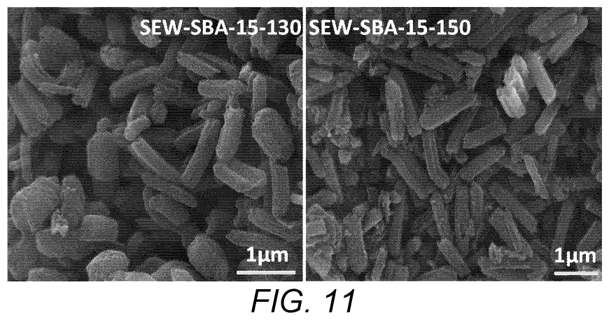

The morphology of the SEW-SBA-T-AMT samples was investigated using high resolution scanning electron microscopy. FIG. 3A and FIG. 3B show samples that exhibit distinct rod shaped morphology. The silica templates SEW-SBA-15-T (T=130 or 150° C.) show a distinct rod shaped morphology as shown in FIG. 11. From these results, it can be said the morphology of the silica template has been successfully replicated into the corresponding gMCN. There is a noteworthy difference in the particle shapes for the two carbon nitrides. Clear and distinct rod shaped particles are seen in the SEW-SBA-130-AMT samples. The particles for SEW-SBA-150-AMT samples appear to be shorter and thicker with numerous surface pores. FIG. 3C shows the HR-TEM images of SEW-SBA-150-AMT sample clearly showing the presence of parallel running mesochannels. The low magnification image shows the particle morphology which confirms the observation made from HR-SEM and high magnification image shows the presence of ordered mesoporous structure and confirms the results from N₂ adsorption.

Elemental Analysis.

The carbon, nitrogen, and hydrogen content of the samples was analysed using the CHN analyser. As shown in Table 1, both samples exhibit nearly 50% Nitrogen content and about 30% carbon content and nearly 2.5% hydrogen. Interestingly, the bulk composition of the two materials is almost identical. It is to be noted here that although the pore diameters of the silica templates are different, the quantity of precursor impregnated is the same. Identical conditions are used for carbonization and silica framework removal, so in theory, the composition of the samples should be nearly same. However, the difference in the pore diameters of the silica template for the same quantity of precursor should result in different wall thicknesses, which is manifest in a slight variation in the colors of these two samples.

FT-IR.

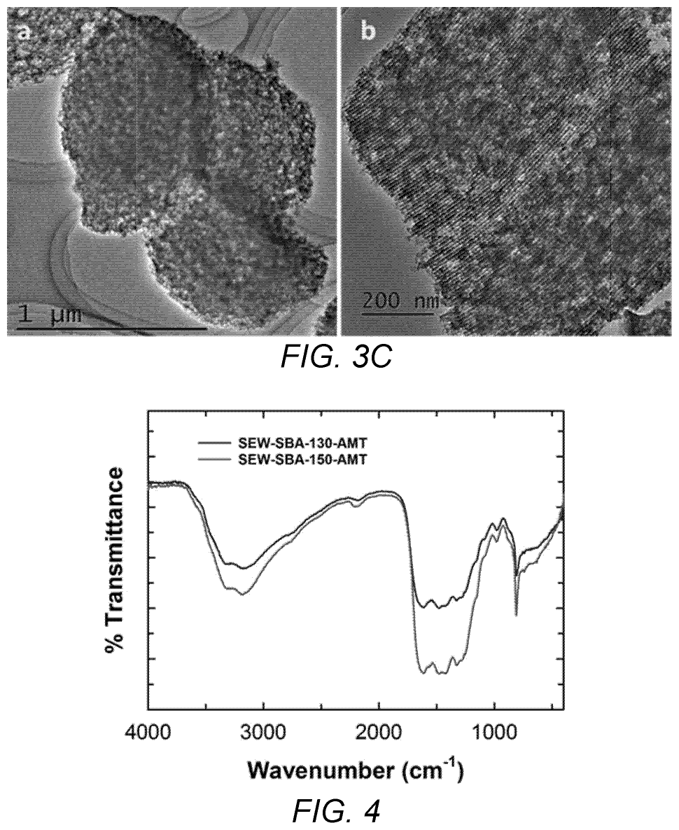

The FT-IR spectra of both the samples are almost overlapping suggesting the presence of almost identical functions (FIG. 4). The appearance of a broad band between 2500-3500 cm⁻¹ is attributed to the presence of surface adsorbed water and residual and terminal —NH and —NH₂ functional groups. While the bands between 1000 and 1700 cm⁻¹ correspond to stretching vibrations of CN heterocycles where at very strong band at approximately 800 cm⁻¹ is ascribed to deformation vibrations of tri-s-triazine rings.

X-ray Photoelectrospectroscopy.

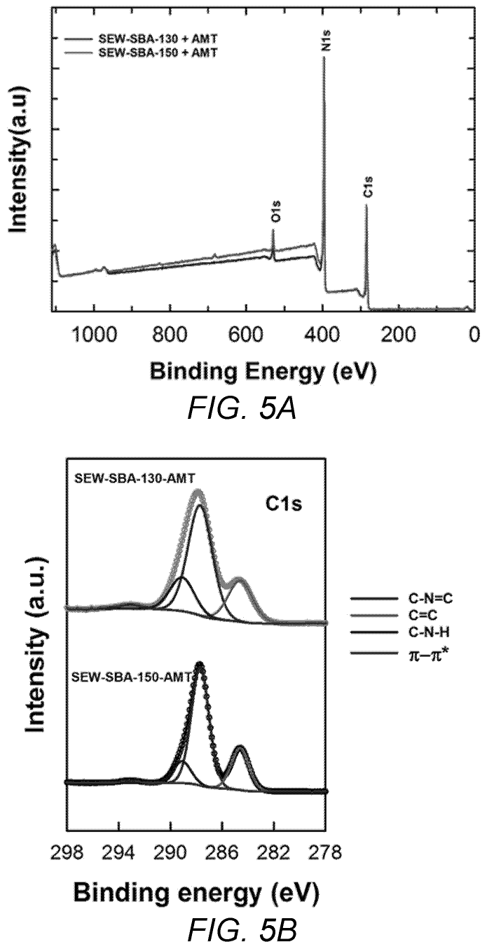

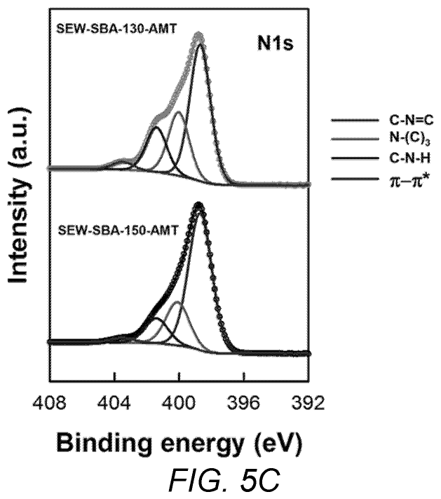

The surface atomic distribution of C, N, and O oxygen atoms was investigated by recording the survey spectra of these samples as shown in Table 1 and in FIG. 5A. From the survey spectra, it is determined that the surface of these samples have more N atoms than carbon atoms with a very small quantity of surface oxygen atoms. Also for both the samples, the surface spectra nearly overlap suggesting that pore diameter tuning does not alter the surface atomic composition of the materials. The surface composition follows the similar pattern as seen in the bulk elemental analysis. However, it is to be noted that XPS being a surface technique measures atomic composition up to a depth of 10 nm from the top exposed surface. Consequently, it is possible to have higher concentration of C and N atoms because of segregation of atoms within the top 10 nm layer of material and so the results from survey spectra may not be in complete agreement with the bulk elemental compositions.

The nature and co-ordination of C and N was investigated using high resolution C1s and N1s spectra as shown in FIG. 5B and FIG. 5C respectively. The C1s spectra in FIG. 5B was deconvoluted into 4 peaks and assigned to different bonding groups as shown in Table 2. The peak at 287.7 eV was assigned to C—N═C, the peak at 284.6 eV was assigned to C═C and the peak at 289.1 eV was assigned to C—N—H bonding groups while the peak at 293.1 eV was assigned to π-π* bonds. The N1s spectra in FIG. 5C was deconvoluted into four peaks as shown in Table 2. The peak at 398.3 eV was assigned to C—N═C, the peak at 400.1 eV was assigned to nitrogen trigonally bonded to three other carbon atoms (N—C₃), the peak at 401.4 eV was assigned to C—N—H groups and the peak 403.5 eV was assigned to π-π*.

Near Edge X-ray Absorption Fine Structure (NEXAFS).

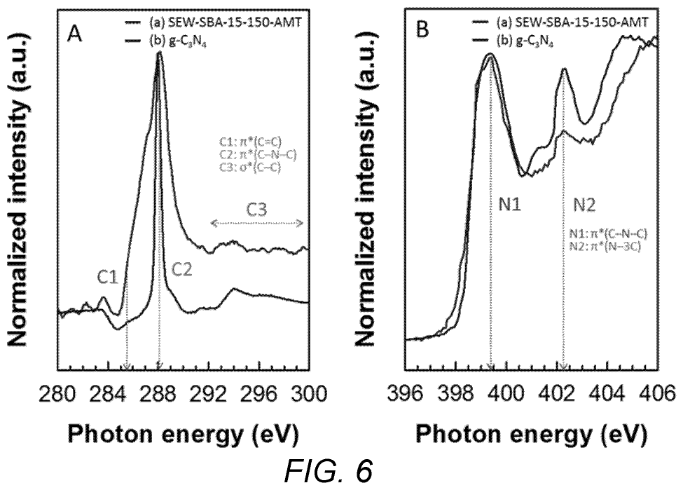

Synchroton based NEXAFS spectra was recorded for the SEW-SBA-150-AMT sample to further understand the chemical bonding of C and N in the sample as shown in C K-edge (FIG. 6A) and N K-edge (FIG. 6B) for SEW-SBA-150-AMT. From FIG. 6A, it can be seen that the characteristic resonances of graphitic carbon nitride occur at different photo energy values such as π*_{C=C} (C1) at 285.6 eV, π*_{C-N-C} (C2) at 288.0 eV, σ*_{C-C} (C3) at around 294 eV, and structural defects. From FIG. 6B, two typical π* resonances can be observed occurring at photon energies of 399.4 and 402.3 eV, which correspond to aromatic C—N—C coordination in one tri-s-triazine heteroring (N1) and N-3C bridging among three tri-s-triazine moieties (N2), respectively. In comparison to the non-porous graphitic C₃N₄ sample, FD150-DAMG show well pronounced graphitic bonding characteristics.

CO₂ Adsorption.

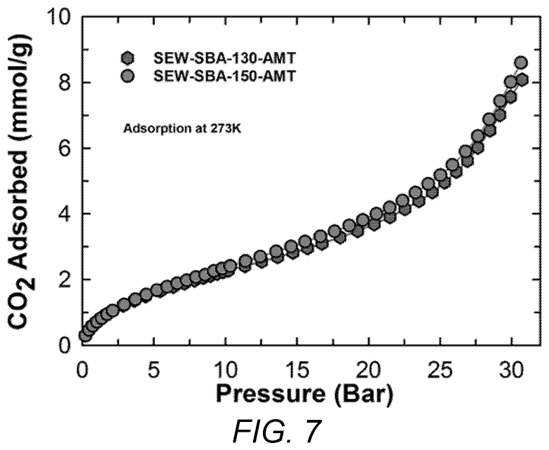

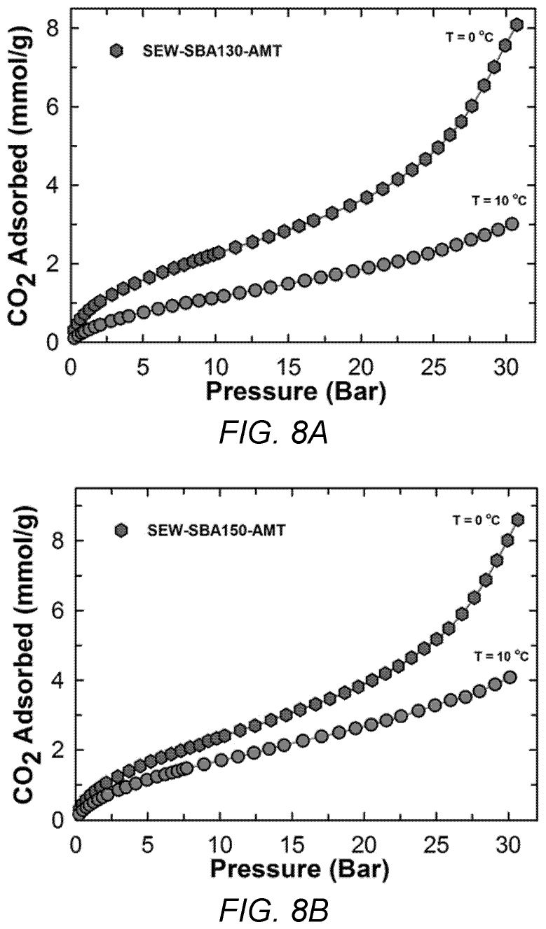

The gMCN samples were used as adsorbed for CO₂ at two different temperatures of 273K and 283K and pressure up to 30 bar. The CO₂ adsorption isotherms recorded at 273K for the two samples are shown in FIG. 7. The CO₂ adsorption capacity of these materials are 8.1 and 8.6 mmol/g for SEW-SBA-130-AMT and SEW-SBA-150-AMT respectively. For materials with not very high surface area and high nitrogen content, the adsorption capacity is remarkably impressive in comparison with mesoporous carbon prepared with controlled morphology and has a high surface area of ca. 1200 m²/g shows a CO₂ adsorption capacity of 24.5 mmol/g at 273K and 30 bar pressure. CO₂ adsorption on a porous material is mainly dependent on the BET surface area and the presence of basic sites or basic functional moieties. However, it has been found that CO₂ adsorption is dictated by a combination of these two factors. One single factor does not dictate CO₂ adsorption capacity. In the present case, the BET surface areas of the two materials is in the similar range and the bulk nitrogen composition is also nearly same. Based on these characteristics, it stands to reason that the CO₂ adsorption capacity would also be nearly same. The effect of the analysis temperature was studied by recording the isotherms for SEW-SBA-T-AMT samples at 283 K and 30 bar as shown in FIG. 8A and FIG. 8B. From the isotherms, it is clear that increasing the analysis temperature decreases the adsorption capacity of the materials drastically, which suggests that the CO₂ adsorption process is exothermic in nature and is favorable at lower temperature.

Isosteric Heat of Adsorption.

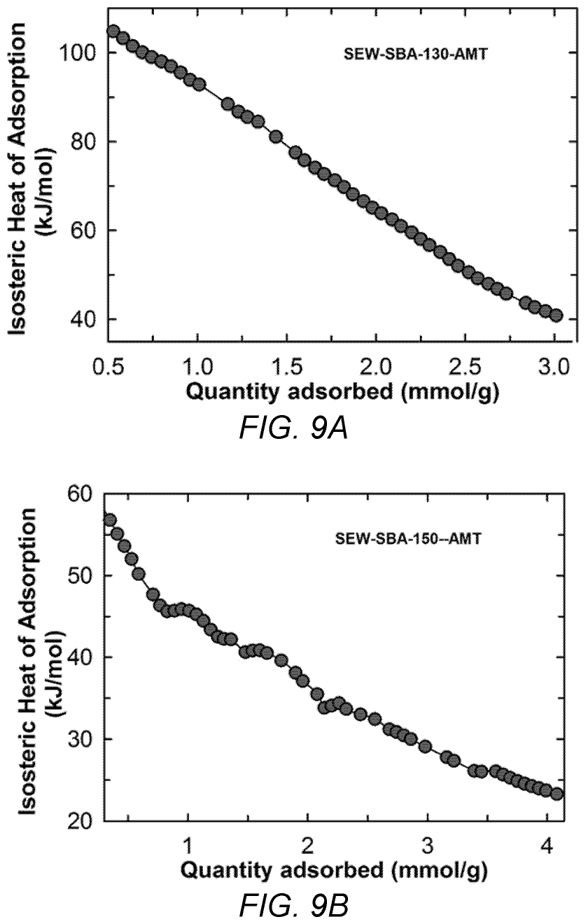

The strength of interaction between gMCN and CO₂ molecules was quantified by calculating the isosteric heat of adsorption using the isotherms calculated at 273K and 283K and the Clausius-Clayperon equation. The isosteric heat of adsorptions for the two samples are shown in FIG. 9. For SEW-SBA-130-AMT sample, the isosteric heat of adsorption varies in the range 40-105 kJ/mol which is an extremely high value and suggests very strong interaction between gMCN substract and CO₂ molecules. For SEW-SBA-150-AMT sample, the isosteric heat of adsorption varies in the range 23.5-57 mmol/g which is reasonably high and suggest intermediate level of interaction. In comparison, it is clear that the interaction is much stronger in case of SEW-SBA-130-AMT sample as compared to SEW-SBA-150-AMT, although the overall adsorption capacity is higher for both.

TABLE 1
(Textural parameters, CO₂ adsorption and elemental
composition of SEW-SBA-T-AMT samples)

| | | | | ^{#}CO₂ | | | | | | | |
|---|---|---|---|---|---|---|---|---|---|---|---|
| | S.A | P.D | P.V | (mmol/g) | | XPS (%) | | | CHN (%) | | |
| Sample | (m²/g) | (nm) | (cm³/g) | 273K | 283K | C | N | O | C | N | H |
| SEW-SBA- | 285 | 4.4 | 0.43 | 8.1 | 3.0 | 47.1 | 50 | 3.1 | 33.2 | 48.1 | 2.5 |
| 130-AMT | | | | | | | | | | | |
| SEW-SBA- | 234 | 5.6 | 0.67 | 8.6 | 4.1 | 38.4 | 59.4 | 1.8 | 35.2 | 49 | 2.3 |
| 150-AMT | | | | | | | | | | | |

^{#}CO₂ adsorption carried out using dry CO₂ gas and pressure up to 30 bar.

TABLE 2
(XPS deconvoluted peak positions of C1s and N1s spectra of SEW-SBA-T-AMT samples)

| | C—N═C | C═C | C—N—H | π- π* | C—N═C | N—(C)₃ | C—N—H | π- π* |
|---|---|---|---|---|---|---|---|---|
| | 287.7 eV | 284.6 eV | 289.1 eV | 293.1 eV | 398.3 eV | 400.1 eV | 401.4 eV | 403.5 eV |
| SEW-SBA- | 58.4% | 21.7% | 17.8% | 2.1% | 54.1% | 25.2% | 17.6% | 3.1% |
| 130-AMT | | | | | | | | |
| SEW-SBA- | 64.0% | 22.9% | 11.8% | 1.3% | 65.3% | 20.6% | 11.9% | 2.2% |
| 150-AMT | | | | | | | | |

Described herein is an environmentally benign method for producing 2D mesoporous carbon nitride with hexagonally arranged pores, high nitrogen content, and rod shaped morphology using silica template prepared from a calcination free route. The materials exhibit high structural ordering and high degree of graphitic layered structure. The maximum CO₂ adsorption capacity was found to be 8.6 mmol/g for sample with BET surface area of 235 m²/g at 273K and 30 bar.

1. A nitrogen rich two dimensional hexagonal C₃N₄₊ type mesoporous graphitic carbon nitride (gMCN) material having a rod shape morphology, an average pore diameter between 4 to 6 nm, and a N/C ratio of 1.35 to 1.6.

2. The material of claim 1, wherein the N/C ratio is 1.4 to 1.5.

3. The material of claim 1, wherein the gMCN is derived from a cyclic amino-triazole precursor, preferably 3-amino-1,2,4-triazole.

4. The material of claim 1, wherein the material has a BET surface area of 230 to 300 m²/g.

5. The material of claim 1, wherein the material has a total pore volume of 0.4-0.7 cm³/g.

6. The material of claim 1, wherein the gMCN has a CO₂ adsorption capacity of 7.5 to 10.0 mmol/g at 273K and 30 bar.

7. A method of synthesizing a two dimensional carbon nitride material formed from a cyclic amino-triazole precursor comprising:
(a) contacting a SBA-15 silica template with an aqueous cyclic amino-triazole and hydrogen chloride (HCl) precursor solution forming a templated reaction mixture, wherein the silica template is formed by:
(i) adding tetraethylorthosilicate (TEOS) to a mixture of P-123 surfactant and hydrogen chloride (HCl) forming a template reaction mixture;
(ii) incubating the template reaction mixture at a temperature of about 35 to 45° C. for 1 to 4 hours;
(iii) heating the template reaction mixture to 100-200° C. for 1 to 4 days forming a heated template reaction mixture;
(iv) drying the heated template reaction mixture at 100° C. for 5 to 10 hours forming a dried template reaction mixture; and
(v) washing the dried template reaction mixture with ethanol forming the SBA-15 template;
(b) heating the templated reaction mixture to a temperature between 40 and 200° C., preferably between 80 and 120° C. for 4 to 8 hours forming a first heated reaction mixture;
(c) heating the first heated reaction mixture of step (b) to a temperature between 100 and 200° C., preferably between 140 to 180° C. for 4 to 8 hours forming a second heated reaction mixture;
(d) carbonizing the second heated reaction mixture by heating to about 500° C. for 4 to 6 hours forming a hard template/cyclic amino-triazole-based carbon nitride product; and
(e) removing the hard template to form a nitrogen rich two dimensional rod type C₃N₄₊ mesoporous graphitic carbon nitride (gMCN) of claim 1.

8. The method of claim 7, wherein the template reaction mixture is heated at a temperature of about 130° C. forming a SBA-15-130 template.

9. The method of claim 7, wherein the template reaction mixture is heated at a temperature of about 150° C. forming a SBA-15-150 template.

10. The method of claim 7, further comprising crushing the second heated reaction mixture prior to the carbonizing.

11. The method of claim 7, further comprising bringing the second heated mixture to carbonization temperature using a ramping rate of 2 to 4° C./min.

12. The method of claim 7, wherein carbonizing is performed under constant nitrogen flow.

13. The method of claim 7, wherein the cyclic amino-triazole precursor is 3-amino-1,2,4-triazole.

14. The method of claim 7, wherein the first heated reaction mixture is incubated at a temperature of 130° C.

15. The method of claim 7, wherein the first heated reaction mixture is incubated at a temperature of 150° C.

16. The method of claim 7, wherein the template is removed by treating the hard template/cyclic amino-triazole-based carbon nitride product with hydrogen fluoride or an ethanol wash.

17. (canceled)
